(19) United States
(12) Patent Application Publication
(10) Pub. No.: US 2025/0208164 A1
(43) Pub. Date: Jun. 26, 2025

(54) Kalman Filter-Based Estimation of Surface Conductivity and Surface Variations in Scanning Tunneling Microscopy

(71) Applicant: Board of Regents, The University of Texas System, Austin, TX (US)

(72) Inventors: Seyed Omid Reza Moheimani, Allen, TX (US); Richa Mishra, Dallas, TX (US)

(21) Appl. No.: 18/985,609

(22) Filed: Dec. 18, 2024

Related U.S. Application Data
(60) Provisional application No. 63/612,427, filed on Dec. 20, 2023.

(51) Int. Cl. G01Q 30/04; G01Q 60/10; G06T 5/70

(52) U.S. Cl. CPC G01Q 30/04; G01Q 60/10; G06T 5/70; G06T 2207/10056; G06T 2207/20024

(57) ABSTRACT

A computer implemented method for scanning tunneling microscopy is described. The method includes scanning a sample surface at a specific sample bias voltage using a scanning tunneling microscope in constant-current mode; and decoupling effects of surface topology variations from effects of surface conductivity variations comprising estimating surface conductivity, σ, using Kalman filtering comprising modeling process noise as colored noise.

### CROSS-REFERENCE TO RELATED APPLICATION

Referring to the application data sheet filed herewith, this application claims a benefit of priority under 35 U.S.C. 119(e) from co-pending provisional patent application U.S. Ser. No. 63/612,427, filed Dec. 20, 2023, the entire contents of which are hereby expressly incorporated herein by reference for all purposes.

### BACKGROUND

### I. Introduction

### A. Working Principle of the STM

Development of the scanning tunneling microscope (STM) significantly advanced the field of surface science, providing unprecedented resolution at the atomic scale. Owing to its exceptional spatial resolution, the STM has become an indispensable tool for investigating surface topography (imaging), manipulating the atomic structure of surfaces (lithography), and gaining insight on surface electronic properties (spectroscopy). Much of our understanding of the behavior of matter at the atomic scale is due to the STM, making it a cornerstone of modern surface science.

The STM operates by bringing a sharp tip close to a conductive surface and establishing a current between the two objects due to the quantum mechanical phenomenon known as tunneling. The STM utilizes this phenomenon to image the surface with atomic resolution. The distance between the tip and the surface is typically within a few angstroms, and a bias voltage is applied between the probe tip and the surface. This voltage causes electrons to tunnel across the gap. The probability of tunneling decreases exponentially as the distance between the two surfaces increases. By applying a positive voltage to the sample, electrons can tunnel from the tip's occupied states to the sample's unoccupied states and vice versa.

Referring to FIG. 1, an STM 100 is shown operating in constant-current mode. The tip 110 follows a raster pattern to scan the sample 120. The tip 110 and sample 120 are placed in a UHV chamber 130.

The primary mode of STM scanning is the constant-current mode, as shown in FIG. 1. During a scan, the tunneling current changes due to features such as variations in surface topography or electronic structure. A feedback controller maintains a constant tunneling current as the tip is scanned across the surface by adjusting the tip-surface distance. The control signal is plotted against the tip position to obtain a 3-D surface topography.

However, the resulting topography or controller output does not necessarily represent the true topography of a surface since, during a scan, the controller reacts to variations in surface conductivity as well as surface variations. Variations in surface conductivity are due to variations in the energy barrier for tunneling electrons. A lower energy barrier means more electrons can tunnel through, which means higher conductivity and a higher tunneling current. Therefore, the controller retracts the tip to maintain the set-point current. Consequently, the STM topography image combines surface variations and surface electronic features that are difficult to separate.

### B. Existing Methods for Estimation of Surface Parameters

Several methods have been proposed to determine surface electronic properties. These techniques are generally referred to as scanning tunneling spectroscopy (STS).

When studying the electronic structure of a surface, an important objective is to determine the density of states for a specific location. To do this, the feedback loop is disabled, and the tip is held stationary over the surface; then, the current I(V) is measured as a function of the bias voltage, while the voltage is ramped in both directions. Subsequently, the voltage is returned to the value corresponding to the constant-current imaging mode, and the feedback loop is enabled. The slope of the resulting I-V curve, or dI/dV, provides information on the local density of states (LDOS). Although this conventional spectroscopy method can be effective, it can also be time-consuming. Obtaining I-V spectra for every pixel can take several hours, and the resulting images are often degraded by lateral drift.

The spectroscopic mapping of a surface can be obtained quickly by utilizing a feedback loop and adding a modulation signal to the dc bias voltage at a constant tunneling current. This technique allows for the acquisition of a dI/dV image simultaneously with the topography image for a given dc bias voltage. However, as noted in, this method has two main drawbacks. First, the resulting images are likely to be noisy due to the small amplitude of the modulation voltage. Increasing the amplitude of the modulation voltage to obtain a better signal-to-noise ratio may disrupt the feedback loop, resulting in the degradation of the topography image. Second, the I(V) information at very low voltages cannot be accurately captured since the tip-sample distance keeps changing, and the tip may collide with the surface for small sample bias voltages ranging from 0.1 to 1 V.

To address these issues, it is possible to use notch filters tuned to the harmonics of the fundamental modulation frequency, while STM is operating in the spectroscopy mode. Thus, current components at multiples of the modulation frequency are rejected, enabling the feedback loop to operate undisturbed even as the amplitude of the modulation voltage increases. This results in images with a higher signal to-noise ratio.

Another issue with conventional spectroscopy is that the tip-sample distance constantly changes, making it challenging to capture I(V) information at very small voltages. This issue can be addressed by closing the feedback loop on the natural logarithm of differential conductance, In(dI/dV), instead of the natural logarithm of tunneling current. In this approach, the tip-sample distance is regulated even when the applied sample dc bias voltage is zero, allowing for information about the engagement of electronic states for the full range of sample bias voltage. The I-V curve can be obtained orders of magnitude faster than the conventional spectroscopy method.

While these spectroscopic methods provide valuable information on the electronic structure of a surface, they have limitations in directly measuring the surface conductivity, a. However, all these methods obtain the differential conductance, dI/dV, which is considered as an approximate representation of the surface conductivity, σ, since surface variations, h, affect the dI/dV measurements obtained from a lock-in amplifier (LIA). In addition, these methods do not provide a direct means of distinguishing between the effects of electronic and physical properties of the surface on the controller output.

### SUMMARY

Embodiments of this disclosure include a novel method for decoupling surface electronic properties from topographic surface variations in scanning tunneling microscope (STM). In a conventional STM image, these surface properties are mixed, and separating them is nontrivial. Embodiments of this disclosure can perform closed-loop system identification to obtain a dynamic model of the STM. Embodiments can then use this model in conjunction with a Kalman filter (KF) and a disturbance observer to estimate surface conductivity, σ, and surface variations, h, from the measurements obtained during a scan. This is experimentally verified by performing hydrogen depassivation lithography on a Si(100)−2×1:H passivated surface to demonstrate accurately estimating surface conductivity and surface height variations.

There is a need for the following embodiments of the present disclosure. Of course, the present disclosure is not limited to these embodiments.

According to an embodiment of the present disclosure, a computer implemented method for scanning tunneling microscopy comprises: scanning a sample surface at a specific sample bias voltage using a scanning tunneling microscope in constant-current mode; and decoupling effects of surface topology variations from effects of surface conductivity variations comprising estimating surface conductivity, σ, using Kalman filtering comprising predicting and correcting and modeling process noise as colored noise. According to another embodiment of the present disclosure, a computer system comprises: a processor set; a set of one or more computer readable storage media; and program instructions, collectively stored in the set of one or more storage media, for causing the processor set to perform the following computer operations: scanning, by a number of processor units, a sample surface at a specific sample bias voltage using a scanning tunneling microscope in constant-current mode; and decoupling, by a number of processor units, effects of surface topology variations from effects of surface conductivity variations comprising estimating surface conductivity, σ, using Kalman filtering comprising predicting and correcting and-modeling process noise as colored noise. According to another embodiment of the present disclosure, a computer program product comprises: a set of one or more computer-readable storage media; and program instructions, collectively stored in the set of one or more computer-readable storage media, for causing a processor set to perform the following computer operations: scanning, by a number of processor units, a sample surface at a specific sample bias voltage using a scanning tunneling microscope in constant-current mode; and decoupling, by a number of processor units, effects of surface topology variations from effects of surface conductivity variations comprising estimating surface conductivity, σ, using Kalman filtering comprising predicting and correcting and-modeling process noise as colored noise.

These, and other, embodiments of the present disclosure will be better appreciated and understood when considered in conjunction with the following description and the accompanying drawings. It should be understood, however, that the following description, while indicating various embodiments of the present disclosure and numerous specific details thereof, is given for the purpose of illustration and does not imply limitation. Many substitutions, modifications, additions and/or rearrangements may be made within the scope of embodiments of the present disclosure, and embodiments of the present disclosure include all such substitutions, modifications, additions and/or rearrangements.

### BRIEF DESCRIPTION OF THE DRAWINGS

The drawings accompanying and forming part of this specification are included to depict certain embodiments of the present disclosure. A clearer concept of the embodiments described in this application will be readily apparent by referring to the exemplary, and therefore nonlimiting, embodiments illustrated in the drawings (wherein identical reference numerals (if they occur in more than one view) designate the same elements).

The described embodiments may be better understood by reference to one or more of these drawings in combination with the following description presented herein. It should be noted that the features illustrated in the drawings are not necessarily drawn to scale.

FIG. 1 illustrates a schematic of an STM operating in constant-current mode, appropriately labeled PRIOR ART.

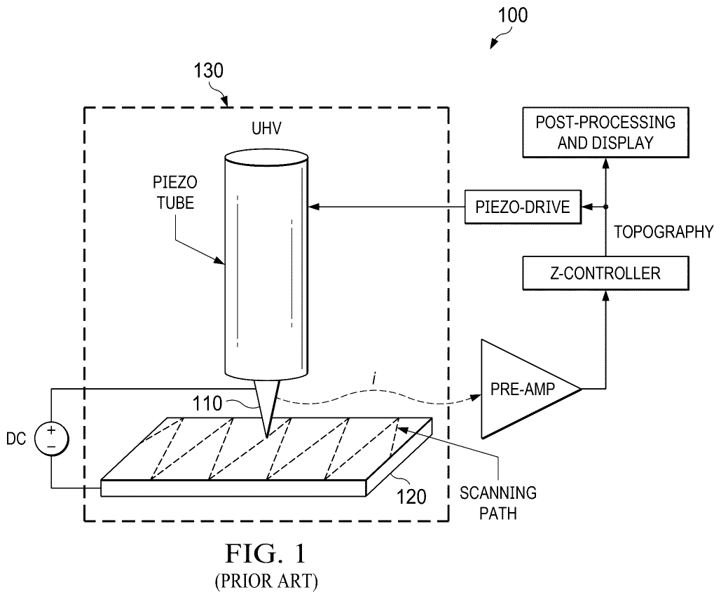

FIG. 2 illustrates a block diagram of the STM feedback loop in the constant-current mode.

FIG. 3 illustrates an STM feedback loop for system identification.

FIG. 4 illustrates a frequency response of an STM obtained through closed-loop system identification.

FIG. 5 illustrates a Z-axis control system block diagram with a self-tuning PI controller.

FIGS. 6A-6C illustrate 3 images comprising of Topo, LBH and LBH gain norm and the cross-sectional profiles of a Si(100)−2×1: H passivated surface.

FIG. 7 illustrates a schematic of a modified STM Z-axis control loop for Kalman Filtering modeling.

FIGS. 8A-8B illustrate expected controller output as the tip scans the surface in STM and actual controller output due to electronic/physical properties of the surface in constant-current mode.

FIG. 9 illustrates a schematic of a disturbance observer for estimating the surface variations, h, modeled as h_{c}.

FIG. 10 illustrates a schematic of an experimental setup including STM, Zyvex Labs' user interface Scanz and Zyvector control box.

FIGS. 11A-11B illustrate topography images of two different Si(100)−2×1: H passivated surface as obtained from Scanz and Zyvector control before image processing.

FIGS. 12A-12J illustrate images and profiles of lithography in a Si(100)−2×1: H passivated surface.

### DETAILED DESCRIPTION

Embodiments presented in the present disclosure and the various features and advantageous details thereof are explained more fully with reference to the nonlimiting embodiments that are illustrated in the accompanying drawings and detailed in the following description. Descriptions of well known materials, techniques, components and equipment are omitted so as not to unnecessarily obscure the embodiments of the present disclosure in detail. It should be understood, however, that the detailed description and the specific examples are given by way of illustration only and not by way of limitation. Various substitutions, modifications, additions and/or rearrangements within the scope of the underlying inventive concept will become apparent to those skilled in the art from this disclosure.

Embodiments can include a novel method for directly estimating surface conductivity, σ, from experimental measurements obtained during constant-current STM at a specific sample bias voltage. This approach is based on a Kalman filtering estimation technique when process noise is modeled as colored noise as opposed to white noise. It turns out that colored process noise modeling is more consistent with the physics of the surface and the data obtained from regular STM imaging. Embodiments can include a disturbance observer to estimate surface variations that are otherwise difficult to differentiate in the controller output as discussed in Section I-A. Examples include data from hydrogen depassivation lithography on a Si(100)−2×1: H passivated surface. The examples show how surface electronic properties and topographic features can be decoupled in STM.

System modeling and theoretical background of the work is presented in Section II. Embodiments based on the Kalman filtering estimation technique are illustrated in Section III. Experimental results are demonstrated in Section IV.

### II. Control Structure and the STM Parameters

This section discusses quantum mechanical phenomena behind the tunneling current and various parameters governing the tunneling current established between the sample and the tip. This section also discusses a modification to the feedback control system architecture, the identification of open-loop STM plant dynamics, and the self-tuning proportional-integral (PI) method required for modeling in this work.

### A. Tunneling Current and the STM Parameters

When a bias voltage is applied to the sample, electrons tunnel through the vacuum between the electrically grounded sharp tip and the sample due to a quantum mechanical phenomenon known as tunneling. This tunneling current, i, is directly proportional to the sample bias voltage and is highly sensitive to the tip-sample distance. Under normal operating conditions, the relationship between tunneling current and tip-sample gap is approximately exponential, that is,

$$i = σ {V}_{b} {e}^{- 1.025 \sqrt{ϕ} δ} \qquad ( 1 )$$

where V_{b}(in V), σ(in nA/V), δ(in nm), and ϕ(in eV) are the bias voltage, the local density of states of the sample, tip-sample distance (tip height), and the “work function” or “local barrier height” (LBH), respectively. The quantum tunneling phenomenon transforms the tip-sample separation, δ, into a current, i. This sub-nanoampere range current is converted to a measurable voltage using a preamplifier gain of R. The natural logarithm of the transformed current linearizes the nonlinear exponential dependence of tunneling current on tip-sample distance (1) as

$$ln ( Ri ) = ln ( R σ {V}_{b} ) - 1.025 \sqrt{ϕ} δ \qquad ( 2 )$$

The tunneling current, i, is a function of several parameters described by (2). Understanding the implications of each parameter on In(Ri) is vital to the design of the STM control system.

In(Ri) and δ: The linear relationship between the natural logarithm of the tunneling current, (In(Ri)), and the distance between the STM tip and the sample surface, δ, have important implications on the control of the STM. By utilizing a linear feedback system to maintain a constant tunneling current, the STM can effectively “feel” the shape of the sample surface and produce a high spatial resolution topographic image.

In(Ri) and ϕ: In addition to providing a high-resolution topographic image of a sample surface, specifically, by measuring the logarithmic derivative of the tunneling current with respect to the tip-sample distance, one can obtain a measure of the work function (ϕ) of the sample. The LBH or work function is defined as the minimum energy required to remove an electron from a solid surface. It represents the physical and electronic properties of the sample surface

$$ϕ = 0.952 {( \frac{d}{d δ} ln ( Ri ) )}^{2} . \qquad ( 3 )$$

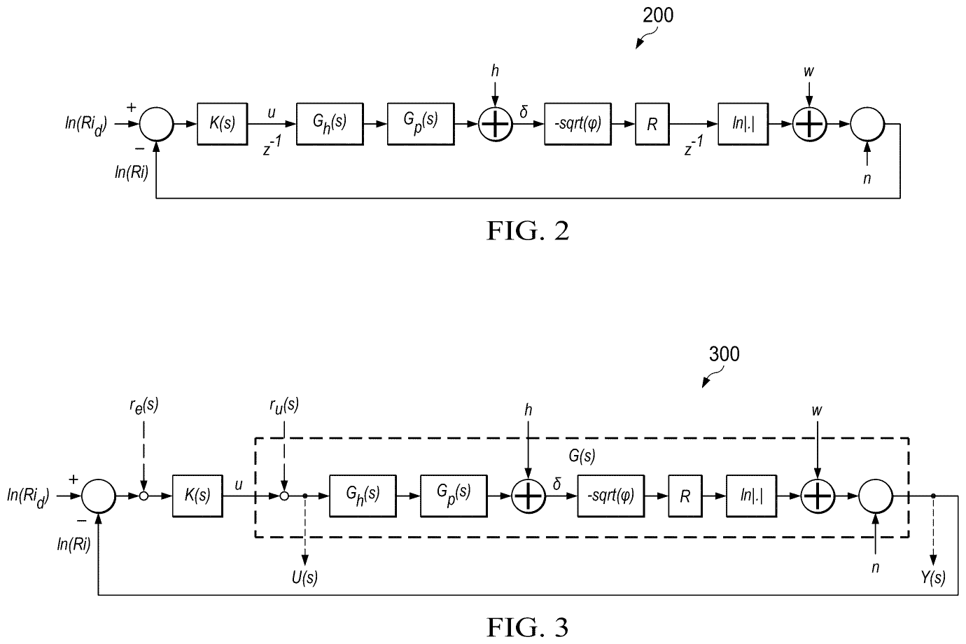

FIG. 2 shows a block diagram 200 of the STM feedback loop in the constant-current mode. The controller command u is amplified by the high-voltage amplifier Gₕ, which drives the piezoactuator Gₚ. As the tip is scanned across the surface, variations in surface topography appear as a disturbance h, causing a change in the tunneling current. This change is regulated by the controller K(s) by adjusting the tip-surface gap, δ. The preamplifier with a gain of R converts the sub-nanoampere range current to a measurable voltage. Here, n is the measurement noise and w=In(RσV_{b}) is constant.

As the STM tip scans across the sample surface, the barrier height can change due to variations in the physical and spatial surface properties. Suppose that the tip encounters an atom on the surface with a different chemical composition or electronic structure than the surrounding atoms. In that case, the barrier height may be higher or lower than the surrounding areas, resulting in variations in the tunneling current. Also, ϕ contributes to the gain of the STM transfer function that the controller regulates, as shown in FIG. 2. Therefore, this term in the tunneling current equation becomes an essential parameter for the estimation. The accurate barrier height estimation investigated is one of the highlights of STM control research.

In(Ri) and σ: In (1), σ, which is known as surface conductivity, depends on the electronic properties of the material and changes from atom to atom on surfaces with defects, adatoms, and buried dopants. Conventionally, to acquire local density of states (LDOS) or differential conductance at a bias voltage, V_{b}, the I-V curve is obtained by keeping the tip at a fixed position and ramping the voltage in both directions. For a small bias voltage, the first derivative of the total tunneling current is proportional to the LDOS of the sample surface

$$\frac{dI}{dV} ∝ σ \qquad ( 4 )$$

Since the tip height tends to vary during a scan on surfaces with many defects or buried dopants, dI/dV measurements cannot accurately reflect spatial variations in a. This parameter contributes to the total tunneling current, and thus, the information it holds needs to be estimated as the tip scans the surface.

### B. Closed-Loop STM System Identification

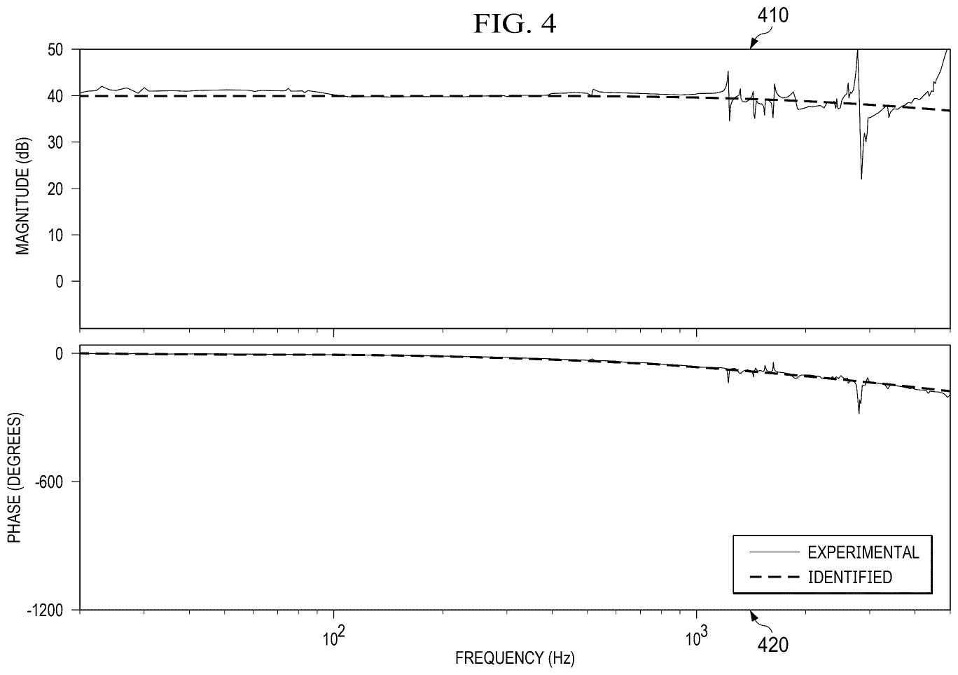

FIG. 3 shows an STM feedback loop 300 for system identification. n, h, In(Ri), In(RσV_{b}), and y_{P} represent sensor noise, surface variation, the set point, and log of measured tunneling current, respectively. rₑ and rᵤ are the exogenous sinusoidal signals with varying frequency (in green), and output responses are U(s) and Y(s) (in blue).

In STM, closed-loop system identification is a crucial step in implementing model-based advanced control techniques. This process involves identifying the transfer function that relates the control signal to the natural logarithm of the resulting tunneling current, and it is performed while the feedback loop is enabled in constant-current mode, as shown in FIG. 3.

The frequency response functions (FRFs) of the system were obtained by adding exogenous inputs, rₑ, to the error signal, and rᵤ to the controller output and then experimentally determining the transfer functions. Specifically, four transfer functions were obtained through this process

$${G}_{{r}_{e} U} ( j , ω ) = \frac{K ( j ω )}{( 1 + K ( j ω ) G ( j ω ) )} \qquad ( 5 )$$

$${G}_{{r}_{e} Y} ( j , ω ) = \frac{K ( j ω ) G ( j ω )}{( 1 + K ( j ω ) G ( j ω ) )} \qquad ( 6 )$$

$${G}_{{r}_{u} U} ( j , ω ) = \frac{1}{( 1 + K ( j ω ) G ( j ω ) )} \qquad ( 7 )$$

$${G}_{{r}_{u} Y} ( j , ω ) = \frac{G ( j ω )}{( 1 + K ( j ω ) G ( j ω ) )} \qquad ( 8 )$$

The STM transfer function G(s) is obtained by dividing the FRFs at each frequency point

$$G ( j ω ) = \frac{{G}_{{r}_{e} Y} ( j ω )}{{G}_{{r}_{e} U} ( j ω )} = \frac{{G}_{{r}_{u} Y} ( j ω )}{{G}_{{r}_{u} U} ( j ω )} \qquad ( 9 )$$

Embodiments can experimentally characterize the STM and identify G(s) while measuring and recording only two signals: the tunneling current In(Ri) obtained from transimpedance amplifier (sensor) with gain R and the control signal u after digital computation, as the feedback loop is enabled. The FRFs are measured when the tip is engaged and the tunneling current establishes over an atom on the surface. The transfer function G(s) captures piezo actuator dynamics and effects of the current tunneling phenomenon.

To obtain the closed-loop FRF of a home-built STM, experiments were conducted using an ONOSOKKI CF 9400 FFT analyzer. The FRFs were obtained by adding a frequency sweep from 10 to 5000 Hz to the error signal. Embodiments can divide this frequency sweep range into three intervals with different averaging and input sweep frequency amplitudes to maintain a good signal-to-noise ratio in the low-frequency range and prevent tip oscillation near the resonance frequency. After obtaining the STM's FRF, embodiments can fit a transfer function, G(s), to obtain a model as

$$G ( s ) = \frac{- 3.27 \times {10}^{6} s + 4.425 \times {10}^{10}}{{s}^{2} + 4.94 \times {10}^{4} s + 4.467 \times {10}^{8}} \qquad ( 10 )$$

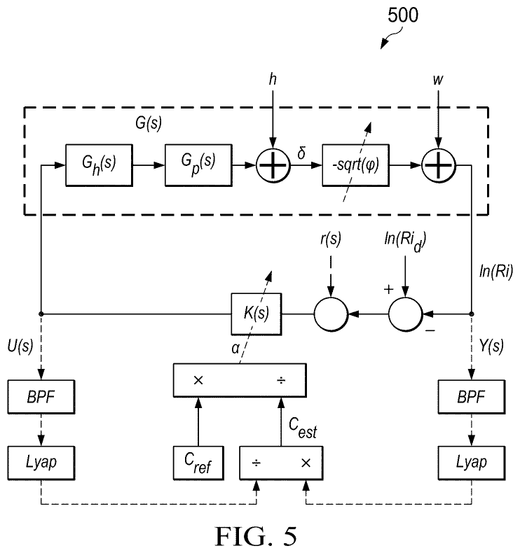

FIG. 4 shows a frequency response of an STM obtained through closed-loop system identification. The measured FRF 410 and estimated G(s) 420 are shown. Since the STM typically operates in a closed-loop bandwidth of 100 or 200 Hz, the fit model adequately captures the plant dynamics over the frequency range of interest.

FIG. 4 depicts the frequency response of the STM plant and the Bode diagram of the estimated transfer function. The STM generally operates with a closed-loop bandwidth of 100-200 Hz and the presented model sufficiently captures the low-frequency dynamics of the system that are relevant to our estimation procedure. It has been observed in FIG. 2 that the dc gain of G(s) is

$${‖ G ( j ω ) ‖}_{ω = 0} = 1.025 \sqrt{ϕ} {k}_{h} {k}_{p} \qquad ( 11 )$$

where kₕ is the dc gain of the high-voltage amplifier, Gₕ(s), and is a constant. Also, kₚ is the dc gain of the piezo actuator Gₚ(s), which depends on the material properties and is, therefore, a constant. Thus, any changes in the dc gain of the STM are attributed to the change in the LBH of the surface, i.e., ϕ.

Variations were reported in the observed dc gain ranging from 48 to 60 dB for the system used in these experiments and a hydrogen-passivated silicon surface. Once the PI controller parameters are fixed, variations in the LBH can lead to system instability, resulting in a tip-sample crash. To address this issue, a self-tuning adaptive method was implemented to estimate changes in the LBH in real time and compensate for these changes by adjusting the PI gain. This method is discussed briefly in Section II-C as it is vital for developing the estimation methodology in this article.

### C. Self-Tuning Z-Axis Control System

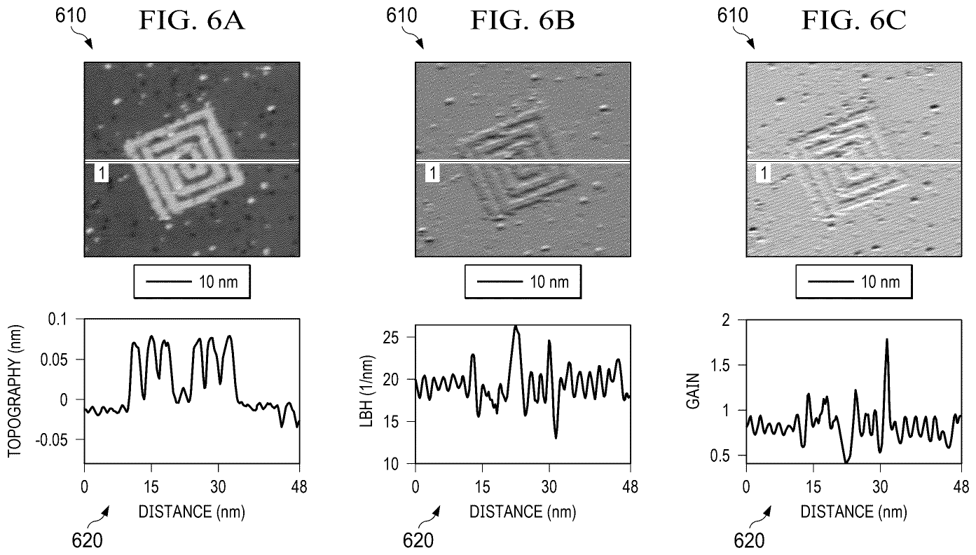

FIG. 5 shows a Z-axis control system block diagram 500 with a self-tuning PI controller.

Embodiments can consider the simplified current model (1), which leads to the STM control loop shown in FIG. 5 with a self-tuning PI controller to compensate for LBH variations. For LBH estimation, embodiments can add a high-frequency sinusoidal signal r(jω) to the error signal as shown in FIG. 5 and then record the responses at the output of the controller and the output of the preamplifier, Y(s) and U(s), respectively. The frequency of the modulating signal should be above the closed-loop bandwidth of the system since the topography information lies in the low-frequency region. Also, it should be carefully selected so that it avoids exciting the system's resonance frequencies. The above procedure can be stated as

$$Y ( j ω ) = \frac{K ( j ω ) G ( j ω )}{1 + K ( j ω ) G ( j ω )} r ( j ω ) \qquad ( 12 )$$

$$Y ( j ω ) = \frac{K ( j ω )}{1 + K ( j ω ) G ( j ω )} r ( j ω ) \qquad ( 13 )$$

Embodiments are interested in the ω component of Y and U in the given control arrangement. Therefore, the responses are passed through the bandpass filter tuned at the ω frequency. The width of the passband determines the LBH estimation bandwidth. Then, these filtered signals are passed through a Lyapunov filter to estimate the magnitudes of the responses. Dividing (12) by (13) yields G(jω), i.e.,

$$\frac{Y ( j ω )}{U ( j ω )} = G ( j ω ) \qquad ( 14 )$$

The magnitude of G(jω) is proportional to LBH

$$\frac{‖ Y ( j ω ) ‖}{‖ U ( j ω ) ‖} = ‖ G ( j ω ) ‖ ∝ ‖ G ( 0 ) ‖ ∝ \sqrt{ϕ} \qquad ( 15 )$$

This study demonstrates that the work function of a Si(100)−2×1: H passivated surface changes as the tip moves from a hydrogen (H) atom to a silicon (Si) atom, which in turn affects the LBH. These changes in LBH affect the loop gain of the STM control loop, which can cause instability in the system.

To address this issue, the simplified model depicted in FIG. 5 shows that as the dc gain of the system, represented by G(s), changes due to the variable nature of LBH (shown in blue arrow), the PI gain adapts (shown in blue arrow) accordingly to prevent the tip from crashing into the surface. The closed-loop system gain is kept constant by multiplying the PI controller with a (LBH gain norm), which is tuned to account for changes in LBH estimations. This makes the STM Z-axis control self-tunable, ensuring stable and accurate measurements. In FIG. 5

$$α = \frac{{c}_{ref}}{{c}_{est}} \qquad ( 16 )$$

Also, the PI controller is defined as

$$K ( s ) = {k}_{i} ( \frac{1}{s} + \frac{1}{{ω}_{c}} ) \qquad ( 17 )$$

where kᵢ is the overall gain and we is the corner frequency.

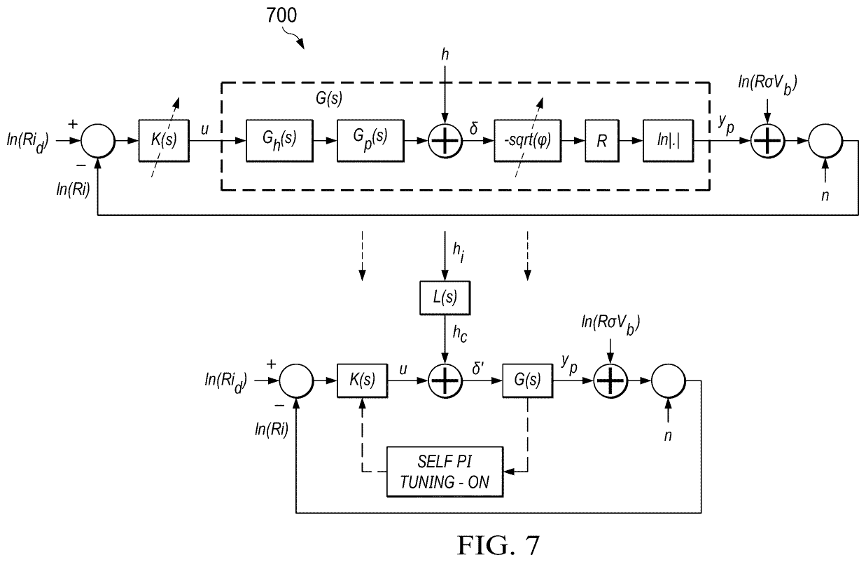

FIGS. 6A-6C show LBH images 610 (top row) and cross-sectional profiles 620 (bottom row) of a Si(100)−2×1: H passivated surface. FIG. 6A shows detrended topography. FIG. 6B shows LBH, i.e., Cₑₛₜ. FIG. 6C shows LBH gain norm, α. Spiral lithography has been performed on Si(100)−2×1: H passivated surface to show variations in LBH as the tip moves from H-atom to Si atom.

The STM control loop depicted in FIG. 5 relies on the accurate determination of C_{ref}, which is obtained by modulating the set point and recording the output signal d(InI)/(dz) using an LIA before the scanning process begins. The result of this approach is shown in FIG. 6B, where LBH varies from high to low over a 48×48 nm area of a Si(100)−2×1: H passivated surface. In this type of surface, the lithography area appears as a bright contrast, but in the LBH image, the contrast is dark as the LBH is lower over dangling bonds (missing H-atoms).

This variability in LBH challenges the stability of the control loop, but the self-tuning PI controller implemented in this system adjusts a to make the overall closed-loop gain constant despite changes in LBH. This ensures that the scanning process remains stable and accurate.

### III. Estimation of Surface Variations and Conductivity

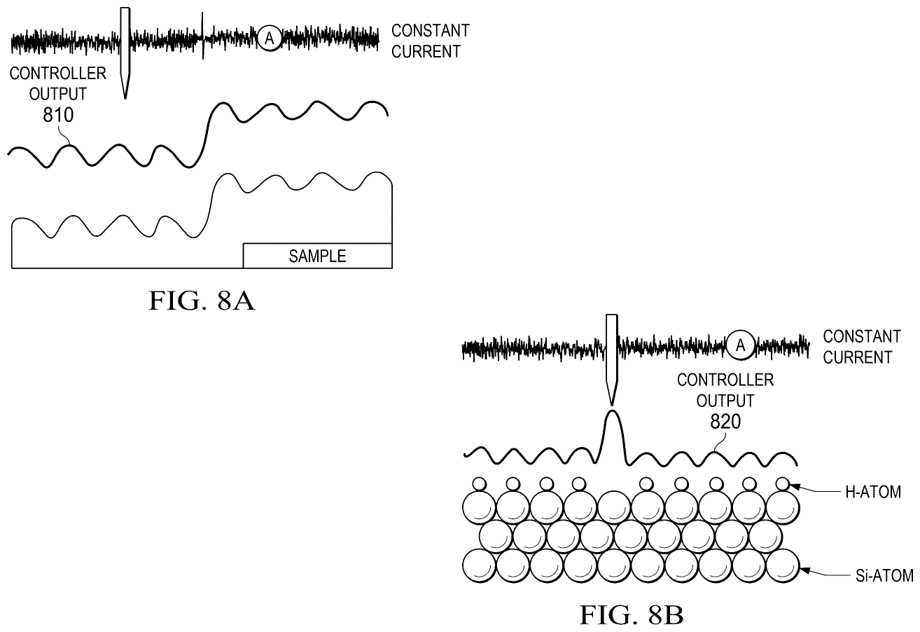

FIG. 7 shows a schematic of an STM Z-axis modified control loop 700 for Kalman Filtering modeling. Here, n, h_{c}, In(Ri), In(RσV_{b}), and yₚ represent sensor noise, projected surface variation modeled as an input disturbance, the (natural) logarithm of tunneling current, natural log of conductivity modeled as an output disturbance, and output of the STM plant, respectively. L(s) is the shaping filter. In this scheme, the LBH estimation and the self-tuning PI gain adaptation method run in the background, in accordance with embodiments of the present disclosure.

Embodiments can set up an augmented Kalman filter (KF) to estimate surface conductivity, a, which appears as an output disturbance, In(RσV_{b}), in FIG. 7. Embodiments can then integrate the estimated output disturbance into a disturbance observer to estimate surface height variations, h, which appear as an input disturbance.

### A. STM Modeling for Estimation

In the STM control system, depicted in FIG. 2, the natural logarithm of the tunneling current is compared to the logarithm of the reference current and the resulting error signal is fed into a PI controller. The output of the controller drives the Z-axis piezo actuator Gₚ(s) via a high-voltage amplifier, Gₕ(s), thereby maintaining a constant current by adjusting the tip height. Here, h denotes the atomic surface height, i.e., the actual surface topography. Scan speed is typically selected so that most surface features fit within the closed-loop bandwidth. Thus, h can be projected as the input disturbance, hᵢ to the plant, shown in FIG. 7. Note that G(s) is the combined dynamics of all STM components in FIG. 2.

In STM, the control signal, u, is plotted as the topography signal. However, it is clear from FIG. 2, and its simplified version in FIG. 7, that the control signal encompasses changes in the topography features, h, as well as electronic and chemical properties of the surface (such as variations in σ and ϕ). Furthermore, w=In(RσV_{b}) is a component of the tunneling current that arises from the electronic properties due to the tip-sample interaction. Hence, w can be modeled as the output disturbance to the states of the STM plant. Previous studies have assumed that In(RσV_{b}) is constant, as depicted in FIG. 2.

System identification experiments are performed, while the tip is stationary with respect to the surface. This means that the model does not capture the effect of LBH variations that appear as a variable gain as the tip scans across the surface. The change in LBH is compensated by tuning the PI gain in real time, based on LBH estimation and summarized above. Thus, the loop gain becomes constant validating the LTI model of the STM as

$${x}_{p}^{\cdot } = {Ax}_{p} + {B}_{u} u + {B}_{u} {h}_{c} \qquad ( 18 )$$

$$y = {C}_{p} {x}_{p} + w + n$$

The STM model, denoted as G(s) in (10), is characterized by state variables, xₚ∈ [symbol] ^{(2×1)}, a state transition matrix, A∈ [symbol] ^{(2×2)}, a control input matrix, Bᵤ∈ [symbol] ^{(2×1)}, and a measurement matrix, Cₚ∈ [symbol] ^{(1×2)}. The control input, u, and sensor output, y, which represents the tunneling current, are associated with the STM control. As illustrated in FIG. 7, the output of the STM plant is represented by yₚ. However, it is inaccessible and cannot be measured directly.

### B. Estimation of In(RσV_{b})

The Kalman filter is a powerful tool for estimating the state of linear stochastic dynamic systems based on observations, a mathematical model of the system, and statistical information about the process and measurement noise. Successful implementation of a Kalman filter requires access to a good model of the process, which could be obtained through system identification experiments.

In sequential Kalman filter estimation, the estimated states and their associated uncertainties are propagated over time using an error covariance matrix. This covariance propagation is used to monitor the convergence of the estimation. Assume that a Gaussian noise process simplifies the posterior estimation of states and results in an optimal estimator, making it a valuable tool in various applications as discussed in.

Here, the STM model in (18) is discretized as

$${x}_{k} = {A}_{k - 1} {x}_{k - 1} + {B}_{{u}_{k - 1}} {u}_{k - 1} + {B}_{{u}_{k - 1}} {h}_{{c}_{k - 1}} \qquad ( 19 )$$

$${y}_{k} = {C}_{k} {x}_{k - 1} + {w}_{k} + {n}_{k}$$

where h_{c}_{ₖ}˜N(0, Qₕ_{_{c}}) and nₖ˜N(0, R̅) measurement noise with covariance matrix Qₕ_{_{c}} ∈ [symbol] and R̅∈ [symbol] , respectively. Here, the process noise, h_{ck}, is modeled as filtered white noise to capture the effects of surface height variations, h, such that the filtered noise remains Gaussian. The shaping filter L(s), in FIG. 7, is a low-pass filter (LPF) that considers the periodicity of dimer rows on the surface. This approach provides a more accurate representation of the actual noise while preserving the observability of the augmented system.

It is worth noting that the power spectrum of the controller output exhibits significant energy in the low-frequency region, indicating the importance of modeling the noise as colored rather than white.

The state-space model of LPF when discretized using the Tustin method is

$${x}_{{f}_{k + 1}} = {A}_{{f}_{k}} {x}_{k - 1} + {B}_{{f}_{k}} {h}_{{i}_{k}} \qquad ( 20 )$$

$${h}_{{c}_{k}} = {C}_{{f}_{k}} {x}_{k} + {D}_{f} {h}_{{i}_{k}}$$

To estimate the unknown disturbance, w, the state augmentation technique is used. The unknown disturbance w is regarded as a state variable and augmented to the state vector as follows:

$${X}_{k} = [ \begin{matrix}{x}_{k} \\ {w}_{k} \\ {x}_{{f}_{k}}\end{matrix} ]$$

The unknown disturbance w is modeled as a constant affected by a small artificial noise h_{w} as

$${w}_{k + 1} = {w}_{k} + {h}_{{w}_{k}} , \qquad ( 21 )$$

$$where$$

$${h}_{{w}_{k}} \sim N ( 0 , {Q}_{w} ) .$$

The state augmentation process transforms a disturbance estimation problem into a standard discrete-time KF. The augmented state equation is driven by the process noise hᵢₖ and h_{wk}. The augmented state-space model for the Kalman filtering technique is shown as follows:

$$[ \begin{matrix}{x}_{k + 1} \\ {w}_{k + 1} \\ {x}_{{f}_{k + 1}}\end{matrix} ] = {\underbrace{[ \begin{matrix}{A}_{k} & 0 & {C}_{{f}_{k}} \\ 0 & 1 & 0 \\ 0 & 0 & {A}_{{f}_{k}}\end{matrix} ]}}_{{A}_{aug}} [ \begin{matrix}{x}_{k} \\ {w}_{k} \\ {x}_{{f}_{k}}\end{matrix} ] + {\underbrace{[ \begin{matrix}{B}_{{u}_{k}} \\ 0 \\ 0\end{matrix} ]}}_{{B}_{aug}} {u}_{k} + {\underbrace{[ \begin{matrix}{B}_{{u}_{k}} {D}_{{f}_{k}} & 0 \\ 0 & 1 \\ {B}_{{f}_{k}} & 0\end{matrix} ]}}_{{G}_{aug}} [ \begin{matrix}{h}_{{i}_{k}} \\ {h}_{{w}_{k}}\end{matrix} ]$$

$${Y}_{k} = {\underbrace{[ \begin{matrix}{C}_{k} & 1 & 0.\end{matrix} ]}}_{{C}_{aug}} [ \begin{matrix}{x}_{k} \\ {w}_{k} \\ {x}_{{f}_{k}}\end{matrix} ] + {n}_{k} .$$

With this augmented state vector, xₖ and wₖ are estimated simultaneously using the Kalman filter algorithm, given that (A_{aug},C_{aug}) is observable and (A_{aug}, G_{aug}) is controllable.

The prediction-correction steps in the Kalman filter algorithm can be applied as follows.

### 1. Prediction Step:

a. A priori error covariance prediction

$${P}_{k}^{-} = {A}_{{aug}_{k - 1}} {P}_{k - 1}^{+} {A}_{{aug}_{k - 1}}^{T} + {G}_{{aug}_{k - 1}} {Q}_{k - 1} {G}_{{aug}_{k - 1}}^{T} . \qquad ( 22 )$$

b. A priori state prediction

$${\hat{X}}_{k}^{-} = {A}_{{aug}_{k - 1}} {\hat{X}}_{k - 1}^{+} {B}_{{aug}_{k - 1}} {u}_{k} . \qquad ( 23 )$$

### 2) Correction Step

a. Kalman gain calculation

$${K}_{k} = {P}_{k}^{-} {{C}_{{aug}_{k}}^{T} ( {C}_{{aug}_{k}} {P}_{k}^{-} {C}_{{aug}_{k}}^{T} + {R}_{k} )}^{- 1} . \qquad ( 24 )$$

b. A posteriori error covariance calculation

$${P}_{k}^{+} = {P}_{k}^{-} - {K}_{k} {C}_{{aug}_{k}} {P}_{k}^{-} . \qquad ( 25 )$$

c. A posteriori state calculation

$${\hat{X}}_{k}^{+} = {\hat{X}}_{k}^{-} - {K}_{k} ( {Y}_{k} - {C}_{{aug}_{k}} . \qquad ( 26 )$$

The subscript k is the sequence of time, and X is an estimate of both the states in X.

### C. Estimation of Surface Height Variations, h

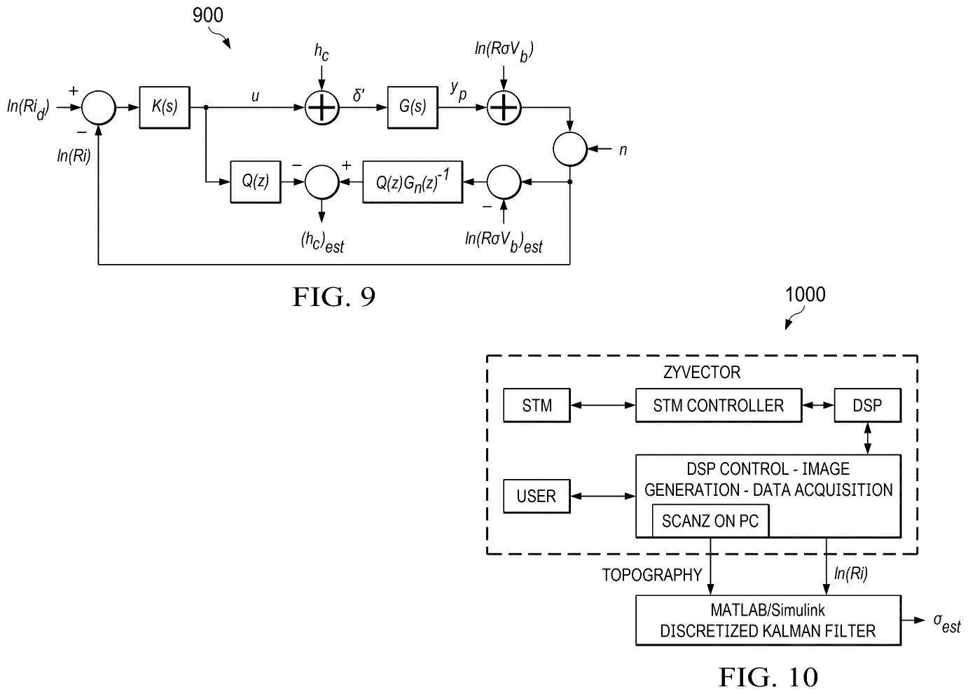

FIG. 8A shows expected controller output 810 as the tip scans the surface in STM. FIG. 8B shows actual controller output 820 due to electronic/physical properties of the surface in constant-current mode.

In Section II, it is pointed out that the tunneling current, i, is influenced by three surface parameters: LBH, surface conductivity, σ, and surface features, h. A feedback controller adjusts the distance between the tip and the sample to maintain a constant current, as shown in FIG. 8A. The controller output, u, is then used to represent the surface topography. However, this assumption is only correct as long as surface electronic properties, captured by the output disturbance, w, in FIG. 7, remain unchanged as the tip scans across the surface. Otherwise, as illustrated in FIG. 8B, the controller output may not exactly map the surface features. Despite this, information about the true surface topography does exist in the control signal, providing an opportunity to estimate the actual surface height variations from the overall system dynamics and the measured current.

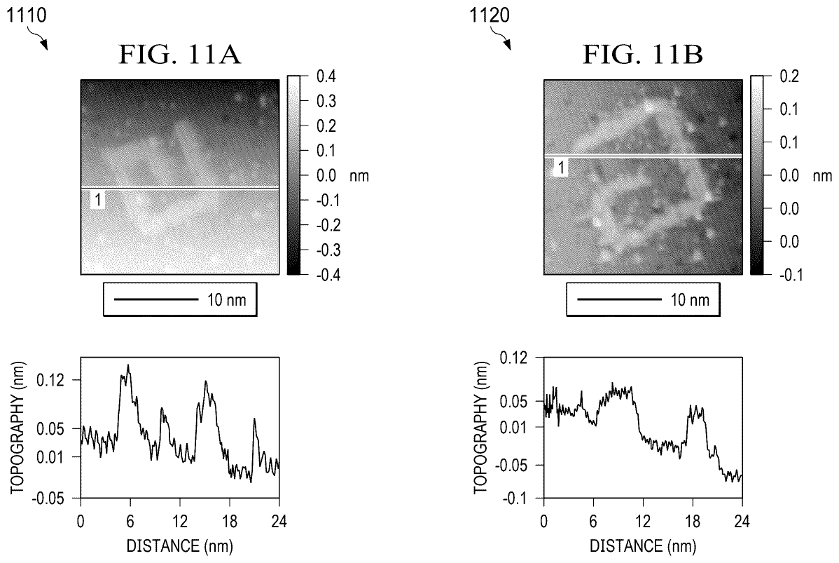

FIG. 9 shows a schematic of a disturbance observer 900 for estimating the surface variations, h, modeled as h_{c}, in accordance with embodiments of the present disclosure.

To estimate the surface variations, h, embodiments design a disturbance observer, as depicted in FIG. 9. The estimated STM plant model is denoted as Gₙ, and an LPF is applied with a transfer function of Q. The input and output disturbances to the plant are represented by h_{c} and In(RσV_{b}), respectively. The estimate of the output disturbance is denoted as In(RσV_{b})ₑₛₜ.

The output of the plant can be expressed as follows:

$$y = {G}_{n} ( u + {h}_{c} ) + {ln ( R σ {V}_{b} )}_{est} \qquad ( 27 )$$

Equation (27) is reordered to estimate the surface variation h_{c}_{ₑₛₜ} entering the STM

$${h}_{{c}_{est}} = {G}_{n}^{- 1} ( y - {ln ( R σ {V}_{b} )}_{est} ) - u \qquad ( 28 )$$

The accuracy of the estimation of surface variation depends on the accurate estimation of In(RσV_{b}). Obtaining a good estimate of surface conductivity, σ, relies on the modeling of process noise. Therefore, embodiments have modeled process noise as colored noise, as opposed to results based on the process noise modeled as white noise.

1. Working Principle of Disturbance Observer: Before implementing the disturbance observer, it is necessary to find the inverse of the estimated STM plant. However, this can be challenging due to the nonminimum phase (NMP) zeros of the plant. Several techniques have been proposed to deal with this issue. Embodiments use the zero-magnitude error tracking controller (ZMETC) since it achieves unity gain at all frequencies. This method amplifies high-frequency components. Hence, there is a need to include an LPF, with unity gain at low frequencies, to obtain the inverse of the plant.

The estimated plant model Gₙ(z) is represented by A(z), which includes poles, and Bₛ(z) and Bᵤ(z), which include stable and unstable zeros of the system, respectively, that is,

$${G}_{n} ( z ) = \frac{B ( z )}{A ( z )} = \frac{{B}_{s} ( z ) {B}_{u} ( z )}{A ( z )} \qquad ( 29 )$$

The unstable zeros Bᵤ(z) are expressed as an nth-order polynomial

$${B}_{u} ( z ) = {b}_{{u}_{n}} {z}^{n} + {b}_{{u}_{n - 1}} {z}^{n - 1} + ⋯ + {b}_{{u}_{0}} \qquad ( 30 )$$

where n is the number of NMP zeros. According to ZMETC, the approximate inverse of G(z) can be obtained by reflecting unstable zeros to stable poles with respect to the unit circle, i.e., zᵤᵢ→1/zᵤᵢ. Therefore, \tilde{G}ₙ(z)⁻¹ can be obtained as

$${\tilde{G}}_{n} ( z ) = \frac{A ( z )}{{B}_{s} ( z ) {B}_{u}^{*} ( z )} \qquad ( 31 )$$

$$where$$

$${B}_{u}^{*} ( z ) = {b}_{{u}_{0}} {z}^{n} + {b}_{{u}_{1}} {z}^{n - 1} + ⋯ + {b}_{{u}_{n}} \qquad ( 32 )$$

In this disturbance observer, to suppress high-frequency noise in measurements, an LPF is needed to fine-tune the open loop for estimating the surface variations, h, as depicted in FIG. 9. Embodiments select this LPF to be Q(s). Typically, Q(s) is designed as 1/(ωᵢs+1), where ωᵢ is a tuning parameter that determines the level of disturbance filtering. The cutoff frequency of the LPF, Q(s), is wᵢ=300 Hz. The cutoff frequency was selected to reject undesirable high-frequency noise. As the available information suggests that disturbances and surface variations, h, only exist in the low-frequency range, a 4th-order LPF with unity dc gain is implemented as Q(s). Also, the 4th-order LPF was selected to minimize the phase lag introduced by the filter on the estimation. Q(s) is fine-tuned around the above values iteratively to meet the desired performance. This LPF is then discretized at 100 kHz.

### IV. Experimental Results

Experimental results were obtained by imaging a Si(100)−2×1: H passivated surface with an ultrahigh vacuum (UHV) STM and apply our approach to estimate the surface conductivity, σ, and surface height variations, h.

### A. Experimental Setup

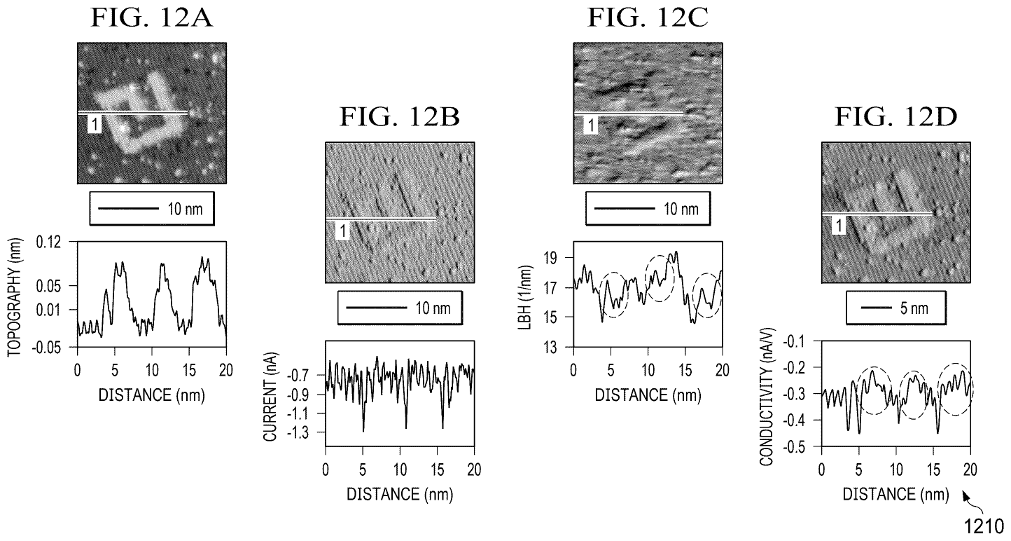

FIG. 10 shows a schematic of an experimental setup 1000 including STM, Zyvex Labs' user interface Scanz and Zyvector control box. Also shown is the implementation of a discretized Kalman filter in MATLAB/Simulink using the experimentally obtained data to estimate surface conductivity σ, in accordance with embodiments of the present disclosure.

The experiments were performed on a Si(100)−2×1: H passivated surface with a tungsten tip. The scanner is operated in UHV at 10⁻¹¹ torr and at room temperature. A Femto DLPCA-200, low-noise current preamplifier with a gain of 10⁹ and bandwidth of 1 kHz, measures the tunneling current. The preamplifier output is sent back to the STM controller for signal conditioning and then to the digital signal processing (DSP) for digitization. Finally, the signal is returned to the computer for image processing, as shown in FIG. 10. The STM controller is implemented in a 20-bit DSP unit TMS320C6713 running at 100 kHz. This sampling frequency is used for recording signals and generating the image. The Scanz software unit provides a graphical user interface to set the scan parameters, controller gains, and mode of operation of STM. The two experiments were conducted in the imaging mode on a different Si(100)−2×1: H passivated surface at a sample bias voltage of −2.5 V with tunneling current set points of 0.75 and 0.5 nA.

TABLE I
PARAMETERS FOR EXPERIMENTAL SETUP

| Parameter | Value | |
|---|---|---|
| Bias Voltage, V_{b} | −2.5 | V |
| Current set-point, i | 0.75/0.5 | nA |
| Rastering speed | 100 | nm/s |
| Modulation frequency | 2 | kHz |
| Sampling frequency | 100 | kHz |
| LBH estimation Bandwidth | 400 | Hz |
| Gain of Gₖ | 13.5 | |
| Piezo Material sensitivity of Gₚ | 54 | nm/V |
| LPF, Q(s) corner frequency, ωᵢ | 2 × pi × 300 | rad/sec |

### B. Results

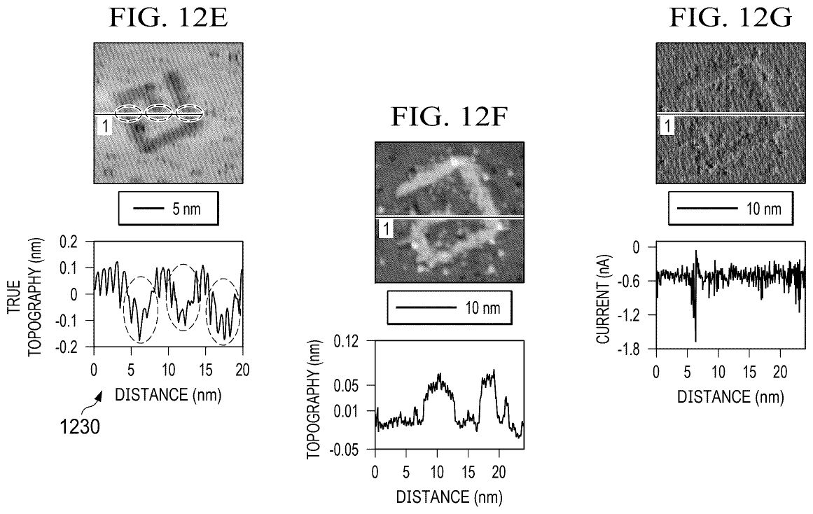

FIGS. 11A-11B illustrate topography images 1110, 1120 of two different Si(100)−2×1: H passivated surfaces as obtained from Scanz and Zyvector control before image processing. Before imaging, spiral patterns of Si dangling bonds were generated by desorbing hydrogen atoms from the surface. Sample bias voltage of −2.5 V with a tunneling current set point of (FIG. 11A) 0.75 and (FIG. 11B) 0.5 nA. Profile line 1, drawn over both the topography images, is represented in the images on the right side.

A 24×24 nm area of a Si(100)−2×1: H passivated surface is imaged at a resolution of 16000×128 pixels. The LBH estimation algorithm and the self-tuning PI controller method are implemented in Scanz. Table I shows the main parameters used for imaging, LBH estimation, and controller tuning in this experiment. The modulation frequency selected for LBH estimation is 2 kHz, significantly larger than the closed-loop system bandwidth. A topography image obtained by Scanz and Zyvector from a Si(100)−2×1: H passivated surface is shown in FIG. 11A and FIG. 11B. The image is a plane surface with dimers of hydrogen atoms (appearing as orange colored rows), bright spots (dangling bonds, i.e., missing H-atoms), and dark spots (missing dimer rows). The surface also includes irregular, brighter spots. The nature of these spots is not clearly known, but they represent contamination. Two separate experiments were conducted several days apart on two different samples, with different tips and different tunneling currents to implement our approach on different surface image data. Lithography was performed to understand the estimation of surface conductivity, σ, and surface variations, h, better. The obtained images have a tilt (trend) moving downward as the tip scans the surface line by line. The tilt in the surface can be in both directions depending on the relative orientation of the surface of Si(100)−2×1: H with respect to the tip.

Surface height variations, h, affect the tunneling current, causing it to deviate from the set point. A PI controller maintains a constant natural log of tunneling current by adjusting the tip-sample separation, δ. Consequently, the controller output, u, reflects the topography of the surface, including any step edges or tilts. A Kalman filter estimator is designed to account for stationary process noise caused by such variations. The STM image obtained from Scanz is postprocessed in MATLAB to remove the trend in the topography image data, resulting in detrended topography data in displacement units (in nm). These data are converted from control voltage using a calibration factor of 540 nm/10 V, with 128 scan lines containing 16000 measurements obtained at sampling intervals of 10 μs. The detrended topography data, along with the natural logarithm of tunneling current, are fed as inputs to the discretized Kalman filter model, which is implemented in MATLAB/Simulink at a sampling frequency of 100 kHz. To set the measurement noise covariance, denoted by \tilde{R}, the variance (σ_{\tilde{R}}²) of the signal In(Ri) is used. This signal is recorded using a dSPACE system and imported into MATLAB to obtain the variance of measurement noise, with \tilde{R} chosen as \tilde{R}₁=0.04 and \tilde{R}₂=0.12, respectively, for the first and second experiments. The process noise covariance matrix, Q, is the only tunable variable determining the estimation bandwidth. To avoid noisy state estimations, Q is selected as large as possible while still maintaining stability, with Q₁=diag(10⁻⁵, 10⁻⁶) and Q₂=diag(10⁻⁵,10⁻⁵). The discretized Kalman filter is then run sequentially in MATLAB to obtain an estimate of In(RσV_{b}) for every scan line. With the preamplifier gain, R, and the sample bias voltage, V_{b} known, the estimate of surface conductivity, σ, can be determined.

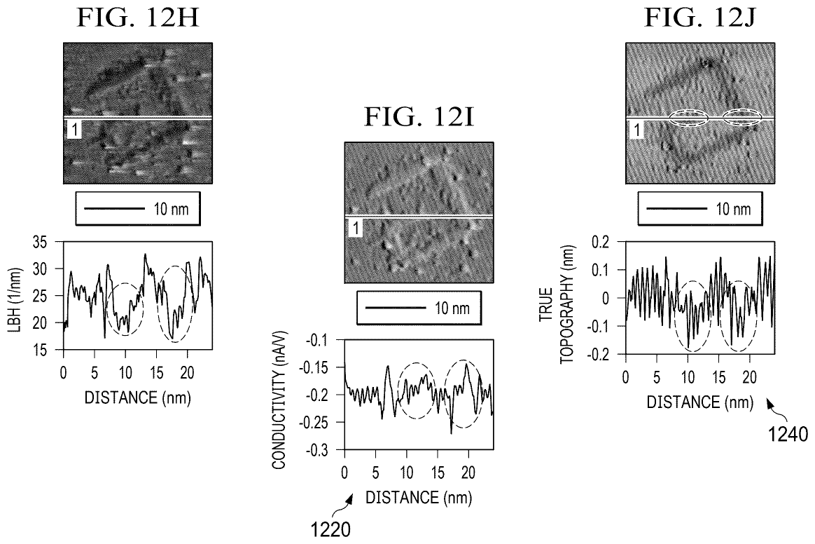

FIGS. 12A-12J show images and profiles of lithography in a Si(100)−2×1: H passivated surface. FIGS. 12A and 12F show detrended topography. FIGS. 12B and 12G show tunneling current. FIGS. 12C and 12H show LBH. FIGS. 12D and 12I show estimated conductivity 1210, 1220. FIGS. 12E and 12J show estimated surface variations 1230, 1240 (true topography). Surface features to observe are circled in the left-hand images of FIG. 12E and FIG. 12J, and respective surface features are circled in the right-hand profiles of (FIG. 12C, FIG. 12D, FIG. 12E) and (FIG. 12H, FIG. 12I and FIG. 12J).

The detrended topography, tunneling current, LBH, estimated surface conductivity, and surface variations (true topography) are shown in FIGS. 12A-12J with their respective profiles. Profile 1 is superimposed on the spiral lithography and appears as a bright contrast in the first experiment, as shown in FIG. 12A, with the corresponding change in the profile depicted as three peaks as it is drawn over three lines of lithography. The tunneling current remains constant, as expected, as shown in FIG. 12B.

To confirm the accuracy of the surface conductivity, σ, estimation, an LBH image is also obtained. As described in Section II, the LBH represents the minimum energy required to remove an electron from the surface. From the image in FIG. 12C, it can be observed that the LBH is low over the missing H-atoms (dangling bonds), resulting in the lithography pattern appearing as a dark region. As anticipated, the surface conductivity at this point is high since Si-atoms are more reactive than H-atoms, as evident from the profile of the estimated conductivity in FIG. 12D. Once an estimate of In(RσV_{b}) is obtained, embodiments can utilize this estimation in a disturbance observer to estimate the surface height variations, h. FIG. 12E shows that the estimation of surface variation results in a dark contrast wherever an H-atom has been removed. The topography profile exhibits troughs over the lithography area. A noticeable difference is observed comparing the topography and surface variation images. While the topography image displays the effects of surface conductivity and surface variations, the surface variation image clearly highlights the true surface topography.

The surface image obtained from the second experiment is plotted in FIG. 12C. The surface profile over line 1 is sketched next to the topography image. The data obtained in this experiment were significantly noisier than the first experiment, as shown in FIG. 12A. The same procedure was applied to the second set of experimental data as was applied to the first set of experimental data. LBH is low on a dangling bond [see FIG. 12H] and that the estimated surface conductivity, σ, is high on dangling bonds [see FIG. 12I]. These observations are in agreement with those made based on the first experiment data. The surface variation, h, estimation clearly shows the missing H-atom as a drop in surface height of approximately 100 pm (inside red circle), which is the diameter of the hydrogen atom [see FIGS. 12E and 12J].

### V. Conclusion

Embodiments present a novel framework for estimating surface conductivity, σ, and surface height variations, h, in STM. Embodiments use a Kalman filter estimation technique followed by a disturbance observer to decouple the effects of surface variations from surface conductivity. Embodiments obtain a more accurate estimation of the true topography map of the surface, overcoming the limitations of conventional STM where the controller output is affected by surface variations and electronic properties. Embodiments are an important because they are the first successful demonstration of decoupling surface variations and electronic properties in STM. Embodiments that include augmented Kalman filter estimation methods are particularly beneficial when several tips operate in parallel, and/or a large dataset is available for estimation. Embodiments can estimate surface parameters without additional hardware based on this estimation method. Embodiments provide a valuable tool for understanding surface properties and their effects on STM imaging.

### Definitions

Computer readable storage media is intended to mean a physical or tangible storage device used to store program instructions rather than a medium that propagates or transmits program instructions. Computer readable storage media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. A computer readable medium is intended to mean non-transitory computer or machine readable program elements translatable for implementing a method of this disclosure. The terms program and software and/or the phrases program elements, computer program and computer software are intended to mean a sequence of instructions designed for execution on a computer system (e.g., a program and/or computer program, may include a subroutine, a function, a procedure, an object method, an object implementation, an executable application, an applet, a servlet, a source code, an object code, a shared library/dynamic load library and/or other sequence of instructions designed for execution on a computer or computer system).

The term uniformly is intended to mean unvarying or deviating very little from a given and/or expected value (e.g, within 10% of). The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically. The term proximate, as used herein, is intended to mean close, near adjacent and/or coincident; and includes spatial situations where specified functions and/or results (if any) can be carried out and/or achieved. The term distal, as used herein, is intended to mean far, away, spaced apart from and/or non-coincident, and includes spatial situation where specified functions and/or results (if any) can be carried out and/or achieved. The term deploying is intended to mean designing, building, shipping, installing and/or operating.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms a and/or an are employed for grammatical style and merely for convenience.

The term plurality is intended to mean two or more than two. The term any is intended to mean all applicable members of a set or at least a subset of all applicable members of the set. The phrase any integer derivable therein is intended to mean an integer between the corresponding numbers recited in the specification. The phrase any range derivable therein is intended to mean any range within such corresponding numbers. The term means, when followed by the term “for” is intended to mean hardware, firmware and/or software for achieving a result. The term step, when followed by the term “for” is intended to mean a (sub)method, (sub)process and/or (sub)routine for achieving the recited result. Unless otherwise defined, all technical and scientific terms used herein have the same meaning as commonly understood by one of ordinary skill in the art to which this present disclosure belongs. In case of conflict, the present specification, including definitions, will control.

The described embodiments and examples are illustrative only and not intended to be limiting. Although embodiments of the present disclosure can be implemented separately, embodiments of the present disclosure may be integrated into the system(s) with which they are associated. All the embodiments of the present disclosure disclosed herein can be made and used without undue experimentation in light of the disclosure. Embodiments of the present disclosure are not limited by theoretical statements (if any) recited herein. The individual steps of embodiments of the present disclosure need not be performed in the disclosed manner, or combined in the disclosed sequences, but may be performed in any and all manner and/or combined in any and all sequences.

Various substitutions, modifications, additions and/or rearrangements of the features of embodiments of the present disclosure may be made without deviating from the scope of the underlying inventive concept. All the disclosed elements and features of each disclosed embodiment can be combined with, or substituted for, the disclosed elements and features of every other disclosed embodiment except where such elements or features are mutually exclusive. The scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” or “mechanism for” or “step for”. Sub-generic embodiments of this disclosure are delineated by the appended independent claims and their equivalents. Specific embodiments of this disclosure are differentiated by the appended dependent claims and their equivalents.

What is claimed is:

1. A computer implemented method for scanning tunneling microscopy, comprising:
scanning a sample surface at a specific sample bias voltage using a scanning tunneling microscope in constant-current mode; and
decoupling effects of surface topology variations from effects of surface conductivity variations comprising estimating surface conductivity, σ, using Kalman filtering comprising predicting and correcting and modeling process noise as colored noise.

2. The computer implemented method for scanning tunneling microscopy method of claim 1, wherein modeling process noise as colored noise comprises using a shaping filter L(s).

3. The computer implemented method for scanning tunneling microscopy method of claim 2, wherein the shaping filter L(s) comprises a low-pass filter (LPF).

4. The computer implemented method for scanning tunneling microscopy method of claim 1, further comprising estimating surface variations, h, using a disturbance observer.

5. The computer implemented method for scanning tunneling microscopy method of claim 1,
wherein predicting comprises an a priori error covariance prediction and an a priori state prediction and
wherein correcting comprises a Kalman gain calculation, a posteriori error covariance calculation, and a posteriori state calculation.

6. The computer implemented method for scanning tunneling microscopy method of claim 1, wherein estimating surface conductivity includes an offline estimation.

7. The computer implemented method for scanning tunneling microscopy method of claim 1, wherein scanning includes scanning a plurality of scanning tunneling microscopy tips in parallel.

8. A computer system comprising:
a processor set;
a set of one or more computer readable storage media;
program instructions, collectively stored in the set of one or more storage media, for causing the processor set to perform the following computer operations:
scanning, by a number of processor units, a sample surface at a specific sample bias voltage using a scanning tunneling microscope in constant-current mode; and
decoupling, by a number of processor units, effects of surface topology variations from effects of surface conductivity variations comprising estimating surface conductivity, σ, using Kalman filtering comprising predicting and correcting and comprising modeling process noise as colored noise.

9. The computer system of claim 8, wherein the program instructions cause the processor set to perform the following computer operations:
wherein modeling process noise as colored noise comprises using a shaping filter L(s).

10. The computer system of claim 9, wherein the program instructions cause the processor set to perform the following computer operations:
wherein the shaping filter L(s) comprises a low-pass filter (LPF).

11. The computer system of claim 8, wherein the program instructions cause the processor set to perform the following computer operations:
estimating surface variations, h, using a disturbance observer.

12. The computer system of claim 8, wherein the program instructions cause the processor set to perform the following computer operations:
wherein predicting comprises an a priori error covariance prediction and an a priori state prediction and
wherein correcting comprises a Kalman gain calculation, a posteriori error covariance calculation, and a posteriori state calculation.

13. The computer system of claim 8, wherein the program instructions cause the processor set to perform the following computer operations:
wherein estimating surface conductivity includes an offline estimation.

14. The computer system of claim 8, wherein the program instructions cause the processor set to perform the following computer operations:
wherein scanning includes scanning a plurality of scanning tunneling microscopy tips in parallel.

15. A computer program product comprising:
a set of one or more computer-readable storage media; and
program instructions, collectively stored in the set of one or more storage media, for causing a processor set to perform the following computer operations:
scanning, by a number of processor units, a sample surface at a specific sample bias voltage using a scanning tunneling microscope in constant-current mode; and
decoupling, by a number of processor units, effects of surface topology variations from effects of surface conductivity variations comprising estimating surface conductivity, σ, using Kalman filtering comprising predicting and correcting and modeling process noise as colored noise.

16. The computer program product of claim 15, wherein the program instructions cause the processor set to perform the following computer operations:
wherein modeling process noise as colored noise comprises using a shaping filter L(s).

17. The computer program product of claim 16, wherein the program instructions cause the processor set to perform the following computer operations:
wherein the shaping filter L(s) comprises a low-pass filter (LPF).

18. The computer program product of claim 15, wherein the program instructions cause the processor set to perform the following computer operations:
estimating surface variations, h, using a disturbance observer.

19. The computer program product of claim 18, wherein the program instructions cause the processor set to perform the following computer operations:
wherein predicting comprises an a priori error covariance prediction and an a priori state prediction and
wherein correcting comprises a Kalman gain calculation, a posteriori error covariance calculation, and a posteriori state calculation.

20. The computer program product of claim 15, wherein the program instructions cause the processor set to perform the following computer operations:
wherein estimating surface conductivity includes an offline estimation.

21. The computer program product of claim 15, wherein the program instructions cause the processor set to perform the following computer operations:
wherein scanning includes scanning a plurality of scanning tunneling microscopy tips in parallel.
